(19) United States
(12) Patent Application Publication
(10) Pub. No.: US 2024/0227464 A1
(43) Pub. Date: Jul. 11, 2024

(54) TIRE, METHOD OF MANUFACTURING TIRE, AND RAW TIRE

(71) Applicant: BRIDGESTONE CORPORATION, Chuo-ku, Tokyo (JP)

(72) Inventor: Fumiya GOTO, Chuo-ku, Tokyo (JP)

(73) Assignee: BRIDGESTONE CORPORATION, Chuo-ku, Tokyo (JP)

(21) Appl. No.: 18/561,438

(22) PCT Filed: Jul. 19, 2022
(86) PCT No.: PCT/JP2022/028110

§ 371 Date: Nov. 16, 2023

(30) Foreign Application Priority Data
Jul. 26, 2021 (JP) 2021-121860

(51) Int. Cl. B60C 19/08; B29D 30/06; B60C 9/04

(52) U.S. Cl. CPC B60C 19/084; B29D 30/0601; B60C 9/04; B60C 2009/0475

(57) ABSTRACT

In a tire of the present disclosure, an overlap width, between a conductive member and a rubber chafer, in an extending direction of the conductive member is 1 mm or more. A method of manufacturing a tire of the present disclosure includes vulcanizing a raw tire in a state such that an overlap width, between a conductive member and a rubber chafer before vulcanization, in an extending direction of the conductive member is 10 mm or more. In a raw tire of the present disclosure, an overlap width, between a conductive member and a rubber chafer before vulcanization, in an extending direction of the conductive member is 10 mm or more.

### TECHNICAL FIELD

The present disclosure relates to a tire, a method of manufacturing a tire, and a raw tire.

### BACKGROUND

For example, a tire including a carcass formed by one or more carcass plies is known, as described in Patent Literature (PTL) 1.

### CITATION LIST

### Patent Literature

PTL 1: JP 2015-20499 A

### SUMMARY

### Technical Problem

In recent years, demand has existed for reducing the rolling resistance in tires. For this reason, the amount of carbon in the coating rubber, for example, is sometimes reduced to decrease the loss tangent of the coating rubber on the carcass plies. However, if the amount of carbon is reduced, the electrical resistance of the coating rubber increases, and the conductive path from the bead portion to the tread surface may be blocked by the carcass plies. In this case, it may be difficult for static electricity transmitted from the vehicle to the bead portion to escape from the tread surface to the road surface.

It is therefore an aim of the present disclosure to provide a tire having a structure that can easily release static electricity from the vehicle to the road surface, a raw tire for manufacturing such a tire, and a method of manufacturing such a tire.

### Solution to Problem

A summary of the present disclosure is as follows.

A tire including:
a pair of bead cores embedded in a pair of bead portions;
a bead filler disposed on a tire radial outer side of the bead cores; and
a rubber chafer disposed on a tire widthwise outer side of the bead filler, wherein
the tire further includes a conductive member, a tire radial inner end of the conductive member is located at a tire radial outer end of the rubber chafer or in a tire radial region that is farther inward in a tire radial direction than the tire radial outer end of the rubber chafer, and
an overlap width, between the conductive member and the rubber chafer, in an extending direction of the conductive member is 1 mm or more.

A method of manufacturing a tire including a pair of bead cores embedded in a pair of bead portions, a bead filler disposed on a tire radial outer side of the bead cores, a rubber chafer disposed on a tire widthwise outer side of the bead filler, and a conductive member, a tire radial inner end of the conductive member being located at a tire radial outer end of the rubber chafer or in a tire radial region that is farther inward in a tire radial direction than the tire radial outer end of the rubber chafer, the method including:
vulcanizing a raw tire in a state such that an overlap width, between the conductive member and the rubber chafer before vulcanization, in an extending direction of the conductive member is 10 mm or more.

A raw tire for manufacturing a tire, the tire including:
a pair of bead cores embedded in a pair of bead portions;
a bead filler disposed on a tire radial outer side of the bead cores; and
a rubber chafer disposed on a tire widthwise outer side of the bead filler, wherein
the raw tire further includes a conductive member,
a tire radial inner end of the conductive member is located at a tire radial outer end of the rubber chafer before vulcanization or in a tire radial region that is farther inward in a tire radial direction than the tire radial outer end of the rubber chafer before vulcanization, and
an overlap width, between the conductive member and the rubber chafer before vulcanization, in an extending direction of the conductive member is 10 mm or more.

### Advantageous Effect

According to the present disclosure, a tire having a structure that can easily release static electricity from the vehicle to the road surface, a raw tire for manufacturing such a tire, and a method of manufacturing such a tire can be provided.

### BRIEF DESCRIPTION OF THE DRAWINGS

In the accompanying drawings:

FIG. 1 is a schematic view of the tire structure of a tire according to an embodiment of the present disclosure; and

FIG. 2 is a schematic view of the structure of a raw tire according to an embodiment of the present disclosure.

### DETAILED DESCRIPTION

Embodiments of the present disclosure are described below in detail with reference to the drawings.

### (Tire)

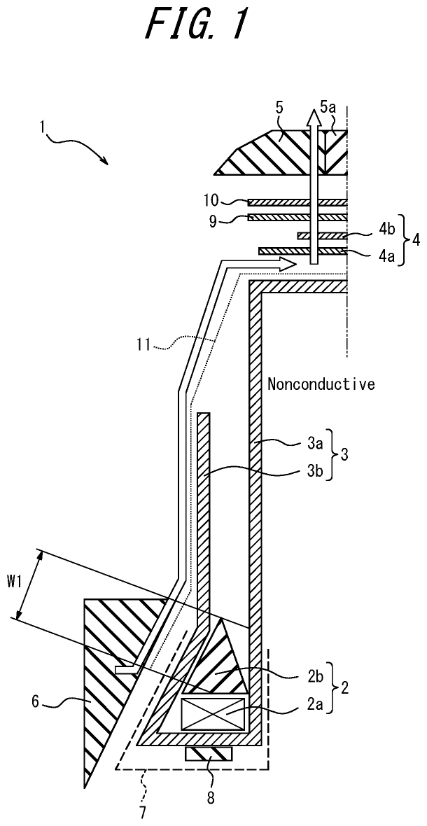

FIG. 1 is a schematic view of the tire structure of a tire according to an embodiment of the present disclosure. This tire 1 is a pneumatic tire in the present example. As illustrated schematically in FIG. 1, the tire 1 includes a pair of bead portions 2, a carcass 3, a reinforcement member disposed on a tire radial outer side of the carcass 3, and a tread portion 5.

In the present example, a pair of bead cores 2a is embedded in the pair of bead portions 2, and a bead filler 2b is disposed on a tire radial outer side of the bead core 2a. The cross-sectional shape and material of the bead core 2a are not particularly limited, and a configuration normally used in tires can be adopted. The bead filler 2b can have a substantially triangular cross-sectional shape, but the cross-sectional shape of the bead filler 2b is not limited to this example, nor is the material particularly limited.

The carcass 3 is formed by one or more carcass plies that include a carcass body portion 3a toroidally spanning the pair of bead cores and a carcass folded-up portion 3b extending from the carcass body portion 3a and folding up around the bead core 2a. In the present embodiment, the carcass plies are made of organic fibers coated with rubber, and the coating rubber has a low loss tangent. This configuration can reduce the rolling resistance of the tire.

Here, the “loss tangent” refers to the ratio (E″/E′) of the dynamic loss elastic modulus E″ value to the dynamic storage modulus E′ value obtained using a dynamic tensile viscoelasticity measuring machine on a test piece of vulcanized rubber having a thickness of 2 mm, a width of 5 mm, and a length of 20 mm under the conditions of a temperature of 60ºC, a frequency of 52 Hz, an initial strain of 2%, and a dynamic strain of 1%. The carcass plies are nonconductive (i.e., do not sufficiently function as a conductive path to release static electricity from inside the tire to the road surface).

A rubber chafer (gum chafer) 6 is disposed on a tire widthwise outer side of the bead filler 2b. The rubber chafer 6 covers the carcass folded-up portion 3b from the tire widthwise outer side. The rubber chafer 6 is conductive. The rubber chafer 6 is disposed on at least some of the contact portion between the bead portion 2 and the rim.

A canvas chafer 7 is disposed around the bead core 2a. The canvas chafer 7 covers the tire radial inner side and both tire widthwise sides of the bead core 2a. The canvas chafer 7 is conductive. The canvas chafer 7 is formed of textile and rubber impregnated in the textile. The textile is formed of warp and weft yarns, and the warp and weft yarns are formed of organic fibers.

As illustrated in FIG. 1, squeegee rubber 8 is disposed on the tire radial inner side of the bead core 2a (in the illustrated example, the tire radial inner side of the carcass folded-up portion 3b and the tire radial inner side of the canvas chafer 7). This prevents contact between the carcass plies and the canvas chafer 7, thereby suppressing failure due to rubbing. The squeegee rubber 8 is nonconductive.

Here, a reinforcement member formed by one or more reinforcement layers is disposed on the tire radial outer side of a crown portion of the carcass 3. In the illustrated example, the reinforcement member includes a belt 4 formed by two belt layers 4a, 4b, a one-layer belt reinforcement layer 9 disposed on the tire radial outer side of the belt 4, and reinforcement rubber (a tread under cushion) 10 disposed on the tire radial outer side of the belt reinforcement layer 9.

The belt layers 4a, 4b are formed by rubber-coated plies of belt cords inclined (for example, at an inclination angle of 30° to 60°) with respect to the tire circumferential direction so as to cross each other between layers. The belt cords can, for example, be steel cords. The belt layers 4a, 4b are conductive. Two belt layers are provided in the present example, but one or more belt layers is sufficient. Also, the inclination angle with respect to the tire circumferential direction is not limited to the aforementioned range.

The belt reinforcement layer 9 is formed by rubber-coated plies of cords extending in the tire circumferential direction. In the present example, the belt layer 9 is a pair of layers covering only the tire widthwise edge of the belt 4. The cords can be steel cords, for example. The belt reinforcement layer 9 is thus nonconductive. In the case of the belt reinforcement layer 9 being layered, the tire widthwise region between the pair of layers forms a conductive path, since no belt layer is provided except at the position corresponding to the belt edge. The belt reinforcement layer 9 has one layer in the present example but can have two or more layers. For example, a so-called cap layer that covers the entire belt width can be further provided between the belt 4 and the layer in the tire radial direction. Alternatively, only a cap layer may be provided. In the case of being provided, the cap layer is conductive. Each reinforcement layer is either conductive, so as to form a conductive path, or nonconductive but only provided in a portion in the tire width direction, so that the area where the reinforcement layer is not provided becomes a conductive path. In the present embodiment, the tire 1 does not necessarily include the belt reinforcement layer 9. Furthermore, the belt reinforcement layer 9 may be disposed on the tire radial inner side of the belt 4.

The reinforcement rubber (tread under cushion) 10 is disposed between the tread portion 5 and the belt reinforcement layer 9 in the tire radial direction in the illustrated example. The tread under cushion 10 is conductive.

The tread portion 5 is not very conductive. The tread portion 5 can, for example, have a so-called cap-and-base structure, with the cap rubber disposed on the tire radial outer side of the base rubber. A portion of the tread portion 5 in the tire width direction is antenna rubber 5a. The antenna rubber 5a is conductive. The antenna rubber 5a can be disposed continuously or intermittently in the tire circumferential direction.

Here, the tire 1 of the present embodiment further includes a conductive member 11. In the present example, the conductive member 11 is a conductive fiber member. The conductive fiber member can, for example, be formed by blending and twisting cotton fibers and pieces of SUS. This enables the fibers to be lightweight and conductive. To reduce weight, the fiber preferably consists of only one strand.

Here, the tire radial inner end of the conductive member 11 is located at the tire radial outer end of the rubber chafer 6 or, as illustrated, in a tire radial region that is farther inward in the tire radial direction than the tire radial outer end of the rubber chafer 6. The rubber chafer 6 and the tire radial inner end of the conductive member 11 are thereby in electrical contact. In the present example, the conductive member 11 extends outward in the tire radial direction from the tire radial inner end to the position of a reinforcement layer, among the one or more reinforcement layers, that is conductive. In the present embodiment, the tire 1 has a pair of conductive members 11, with one in each of the tire widthwise halves divided by the tire equatorial plane. Each conductive member 11 thus has a tire radial outer end. The tire radial outer end of the conductive member 11 terminates at the position of the edge of a reinforcement layer, among the one or more reinforcement layers, that is conductive (the belt layer 4a in the illustrated example). In other words, the tire radial outer end of the conductive member 11 terminates in a tire radial region between the crown portion of the carcass 3 and the reinforcement layer, among the one or more reinforcement layers, that is farthest inward in the tire radial direction and is conductive (the belt layer 4a in the illustrated example). The tire radial outer end of the conductive member 11 and the belt 4a are thereby in electrical contact.

Here, the overlap width, between the conductive member 11 and the rubber chafer 6, in the extending direction of the conductive member 11 is 1 mm or more.

The effects of the tire according to the present embodiment are described below.

First, the tire 1 includes the conductive member 11, and the tire radial inner end of the conductive member 11 is located at the tire radial outer end of the rubber chafer 6 or in a tire radial region that is farther inward in the tire radial direction than the tire radial outer end of the rubber chafer 6. A conductive path can thus be formed for static electricity to escape from the rubber chafer 6 to the road surface through the conductive member 11.

Also, by the overlap width, between the conductive member 11 and the rubber chafer 6, in the extending direction of the conductive member 11 being 1 mm or more, sufficient electrical contact is secured between the rubber chafer 6 and the conductive member 11.

In this way, even when the coating rubber of the carcass plies is configured to reduce rolling resistance as described above, this structure can easily release static electricity from the vehicle to the road surface.

Here, the conductive member 11 preferably extends outward in the tire radial direction from the tire radial inner end to the position of a reinforcement layer, among the one or more reinforcement layers, that is conductive (in the illustrated example, the tire radial outer end of the conductive member 11 terminates at the position of the edge of the belt layer 4a). This brings the conductive member and the reinforcement layer (in the present example, the conductive member 11 and the belt layer 4a) into electrical contact, creating a conductive path for static electricity to escape from the conductive member to the road surface through the reinforcement layer.

The conductive member is preferably a conductive fiber member. An increase in rolling resistance can be suppressed by suppressing an increase in weight due to the addition of the conductive member. In particular, the conductive fiber member is preferably formed by blending and twisting cotton fibers and pieces of SUS, thus making the fiber member lightweight and conductive.

### (Method of Manufacturing a Tire)

Next, a method of manufacturing a tire according to an embodiment of the present disclosure is described. A method of manufacturing a tire of the present embodiment is a method of manufacturing a tire including a pair of bead cores embedded in a pair of bead portions, a bead filler disposed on a tire radial outer side of the bead cores, a rubber chafer disposed on a tire widthwise outer side of the bead filler, and a conductive member, a tire radial inner end of the conductive member being located at a tire radial outer end of the rubber chafer or in a tire radial region that is farther inward in a tire radial direction than the tire radial outer end of the rubber chafer. Examples of tires to be manufactured have already been described in the embodiment of a tire and hence will not be described again.

The method of manufacturing a tire of the present embodiment includes vulcanizing a raw tire in a state such that an overlap width, between the conductive member and the rubber chafer before vulcanization, in an extending direction of the conductive member is 10 mm or more.

During the vulcanization process, unvulcanized rubber flows, and changes in the peripheral shape of the carcass plies occur. As a result, the overlap width, in the direction of extension of the conductive member, between the conductive member and the rubber chafer may vary between the raw tire and the vulcanized tire. Therefore, in consideration of this variance, the raw tire is vulcanized in the vulcanization step in a state such that the overlap width, between the conductive member and the rubber chafer before vulcanization, in the extending direction of the conductive member is 10 mm or more, as described above. By thus ensuring a sufficient overlap width in the vulcanization process, the overlap width, in the direction of extension of the conductive member, between the conductive member and the rubber chafer in the vulcanized tire can reliably be set to 1 mm or more. According to the method of manufacturing a tire of the present embodiment, a tire having a structure that can easily release static electricity from the vehicle to the road surface can thus be obtained.

In the case of the method of manufacturing as well, the conductive member is preferably a conductive fiber member. An increase in rolling resistance can be suppressed by suppressing an increase in weight due to the addition of the conductive member. In particular, the conductive fiber member is preferably formed by blending and twisting cotton fibers and pieces of SUS, thus making the fiber member lightweight and conductive.

Other processes, along with the mold, vulcanization equipment, and the like that are used, can be as usual.

### (Raw Tire)

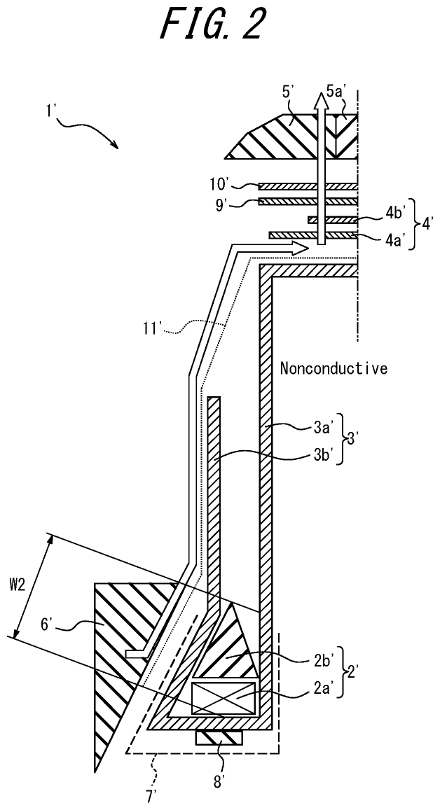

Next, a raw tire according to an embodiment of the present disclosure is described. FIG. 2 is a schematic view of the structure of a raw tire according to an embodiment of the present disclosure. In FIG. 2, the rubber member is in a pre-vulcanized state. In FIG. 2, the corresponding member of the tire in FIG. 1 is marked with a prime (′). As described above, at the time of vulcanization, rubber flows, changes occur in the peripheral shape of the carcass plies, and so forth between the raw tire and the tire, but for simplicity, FIGS. 1 and 2 schematically illustrate an overview of the overlap width W2 in FIG. 2 being greater than the overlap width W1 in FIG. 1. The components of the raw tire are the same as those of a tire except for the rubber members, and the rubber members are the same as those of a tire except for being unvulcanized. A detailed description of the rubber members is therefore omitted.

A raw tire of the present embodiment is a raw tire for manufacturing a tire that includes a pair of bead cores embedded in a pair of bead portions, a bead filler disposed on a tire radial outer side of the bead cores, and a rubber chafer disposed on a tire widthwise outer side of the bead filler. The raw tire of the present embodiment further includes a conductive member. In the raw tire of the present embodiment, a tire radial inner end of the conductive member is located at a tire radial outer end of the rubber chafer before vulcanization or in a tire radial region that is farther inward in a tire radial direction than the tire radial outer end of the rubber chafer before vulcanization, and an overlap width, between the conductive member and the rubber chafer before vulcanization, in an extending direction of the conductive member is 10 mm or more.

The raw tire of the present embodiment includes the conductive member, and the tire radial inner end of the conductive member is located at the tire radial outer end of the rubber chafer before vulcanization or in the tire radial region that is farther inward in the tire radial direction than the tire radial outer end of the rubber chafer before vulcanization. Therefore, in the vulcanized tire, the tire radial inner end of the conductive member is located at the tire radial outer end of the rubber chafer or in the tire radial region that is farther inward in the tire radial direction than the tire radial outer end of the rubber chafer, thereby bringing the rubber chafer and the conductive member into electrical contact.

Furthermore, in the raw tire of the present embodiment, the overlap width, between the conductive member and the rubber chafer before vulcanization, in the extending direction of the conductive member is 10 mm or more. Therefore, at the time of vulcanization, even if unvulcanized rubber flows and changes in the peripheral shape of the carcass plies occur, the overlap width, in the direction of extension of the conductive member, between the conductive member and the rubber chafer in the vulcanized tire can be reliably set to 1 mm or more. According to the raw tire of the present embodiment, a tire having a structure that can easily release static electricity from the vehicle to the road surface can thus be obtained.

In the raw tire as well, the conductive member is preferably a conductive fiber member for the same reasons as described above. In particular, the conductive fiber member is preferably formed by blending and twisting cotton fibers and pieces of SUS, thus making the fiber member lightweight and conductive.

While embodiments of the present disclosure have been described above, the present disclosure is in no way limited to the above embodiments. In the above embodiments, the case of providing a pair of conductive members has been illustrated, but this case is not limiting. A configuration can be adopted with one conductive member extending continuously from one tire widthwise half (for example, the tire radial outer end of the rubber chafer or a tire radial region that is farther inward in the tire radial direction than the tire radial outer end of the rubber chafer) to the other tire widthwise half (for example, the tire radial outer end of the rubber chafer or a tire radial region that is farther inward in the tire radial direction than the tire radial outer end of the rubber chafer). In this case, the conductive member extends across the length of a reinforcement layer, among the one or more reinforcement layers, that is conductive. This configuration also achieves a structure that can easily release static electricity from the vehicle to the road surface.

### REFERENCE SIGNS LIST

1 Tire
2 Bead portion
3 Carcass
4 Belt
5 Tread portion
6 Rubber chafer
7 Canvass chafer
8 Squeegee rubber
9 Belt reinforcement layer
10 Tread under cushion
11 Conductive member

1-4. (canceled)

5. A tire comprising:
a pair of bead cores embedded in a pair of bead portions;
a bead filler disposed on a tire radial outer side of the bead cores; and
a rubber chafer disposed on a tire widthwise outer side of the bead filler, wherein
the tire further comprises a conductive member,
a tire radial inner end of the conductive member is located at a tire radial outer end of the rubber chafer or in a tire radial region that is farther inward in a tire radial direction than the tire radial outer end of the rubber chafer, and
an overlap width, between the conductive member and the rubber chafer, in an extending direction of the conductive member is 1 mm or more.

6. The tire according to claim 5, further comprising a reinforcement member formed by one or more reinforcement layers and disposed on a tire radial outer side of a crown portion of the carcass, wherein
the conductive member extends outward in the tire radial direction from the tire radial inner end to a position of a reinforcement layer, among the one or more reinforcement layers, that is conductive.

7. The tire according to claim 5, wherein the conductive member is a conductive fiber member.

8. A method of manufacturing a tire comprising a pair of bead cores embedded in a pair of bead portions, a bead filler disposed on a tire radial outer side of the bead cores, a rubber chafer disposed on a tire widthwise outer side of the bead filler, and a conductive member, a tire radial inner end of the conductive member being located at a tire radial outer end of the rubber chafer or in a tire radial region that is farther inward in a tire radial direction than the tire radial outer end of the rubber chafer, the method comprising:
vulcanizing a raw tire in a state such that an overlap width, between the conductive member and the rubber chafer before vulcanization, in an extending direction of the conductive member is 10 mm or more.

9. The method of manufacturing a tire according to claim 8,
wherein the conductive member is a conductive fiber member.

10. A raw tire for manufacturing a tire, the tire comprising:
a pair of bead cores embedded in a pair of bead portions;
a bead filler disposed on a tire radial outer side of the bead cores; and
a rubber chafer disposed on a tire widthwise outer side of the bead filler, wherein
the raw tire further comprises a conductive member,
a tire radial inner end of the conductive member is located at a tire radial outer end of the rubber chafer before vulcanization or in a tire radial region that is farther inward in a tire radial direction than the tire radial outer end of the rubber chafer before vulcanization, and
an overlap width, between the conductive member and the rubber chafer before vulcanization, in an extending direction of the conductive member is 10 mm or more.

11. The raw tire according to claim 10, wherein the conductive member is a conductive fiber member.

12. The tire according to claim 6, wherein the conductive member is a conductive fiber member.
